(19) United States
(12) Patent Application Publication
(10) Pub. No.: US 2006/0204305 A1
(43) Pub. Date: Sep. 14, 2006

(54) Head carrier for dot-matrix printer

(75) Inventors: Kiyotaka Nihashi, Mishima-shi (JP); Kazuyoshi Kurihara, Singapore (SG)

Correspondence Address: FRISHAUF, HOLTZ, GOODMAN & CHICK, PC, 220 Fifth Avenue, 16TH Floor, NEW YORK, NY, 10001-7708, US

(73) Assignee: Toshiba Tec Kabushiki Kaisha, Tokyo (JP)

(21) Appl. No.: 11/075,103

(22) Filed: Mar. 8, 2005

(51) Int. Cl. B41J 2/235

(52) U.S. Cl. 400/124.13; 400/124.11

(57) ABSTRACT

A head carrier on which a print head of a dot matrix printer is mounted has a head mount and a mount support. The head mount is fitted to a carrier shaft that is placed in a direction crossing a direction of supplying a recording medium, and moved along the printing surface on a recording medium. A mount support is fitted movably along a carrier guide that is placed with one end connected to the head mount, and the other end placed parallel to the carrier shaft.

### BACKGROUND OF THE INVENTION

1. Field of the Invention

The present invention relates to a head carrier on which a print head of a dot matrix printer is mounted.

2. Description of the Related Art

A dot matrix printer has a print head which moves in the direction intersecting with the direction of conveying a recording medium. The print head is mounted on a head carrier. The head carrier is required to have a high accuracy of positioning the print head on the recording medium. The print head has many wires driven by a solenoid and piezoelectric element.

Each wire is pushed out to print a character on the recording medium by the solenoid or piezoelectric element. The print head is gradually heated during printing because the electric energy conducted to the solenoid or piezoelectric element and the kinetic energy generated by collision of the wire with the recording medium are converted into heat. Therefore, as the printing speed is increased, the print head generates much heat. A heat sink is attached to the print head to prevent the print head from overheating. The heat not radiated by the heat sink is also transmitted to the head carrier.

A dot matrix printer is used also for printing on pressure-sensitive recording paper, as well as printing by using an ink ribbon. Therefore, the print head generates a strong impact during printing.

Therefore, a head carrier is formed by die-casting zinc alloy or aluminum alloy to have sufficient heat resistance and rigidity, as described in Jpn. Pat. Appln. KOKAI Publication No. 05-116420. However, a carrier head formed by die-casting requires incurs high equipment costs, such as for molds, thus the manufacturing unit cost is high. When there arises the necessity for modifying the structure of a carrier head to meet new specifications, a carrier head with a different shape must be manufactured to meet the specifications.

As a result, the price of a dot matrix printer as merchandise is increased. Therefore, it is demanded to decrease the manufacturing costs of the parts around the print head, to allow for variations in configuration of the print head of a dot matrix printer.

### BRIEF SUMMARY OF THE INVENTION

A head carrier according to the present invention, which carries a print head of a dot matrix printer, has a head mount and a mount support. The head mount is fitted to a carrier shaft arranged in the direction crossing the direction of supplying a recording medium, and moved along the printing surface of a recording medium. A mount support is movably fitted along a carrier guide placed with one end connected to the head mount, and the other end placed parallel to the carrier shaft.

Objects and advantages of the invention will become apparent from the description which follows, or may be learned by practice of the invention.

### BRIEF DESCRIPTION OF THE SEVERAL VIEWS OF THE DRAWING

The accompanying drawings illustrate embodiments of the invention, and together with the general description given above and the detailed description given below, serve to explain the principles of the invention.

FIG. 1 is a perspective view showing a head carrier according to a first embodiment of the present invention, with a print head mounted;

FIG. 2 is an exploded perspective view of the head carrier shown in FIG. 1;

FIG. 3 is a sectional view of a head carrier according to a second embodiment of the present invention;

FIG. 4 is a sectional view of a head carrier according to a third embodiment of the present invention;

FIG. 5 is a sectional view of a head carrier according to a fourth embodiment of the present invention;

FIG. 6 is a sectional view of a head carrier according to a fifth embodiment of the present invention;

FIG. 7 is an exploded perspective view showing a head carrier according to a sixth embodiment of the present invention, and a print head to be mounted on the head carrier;

FIG. 8 is an exploded perspective view showing a head carrier according to a seventh embodiment of the present invention, and a print head to be mounted on the head carrier; and

FIG. 9 is an exploded perspective view showing a head carrier according to an eighth embodiment of the present invention.

### DETAILED DESCRIPTION OF THE INVENTION

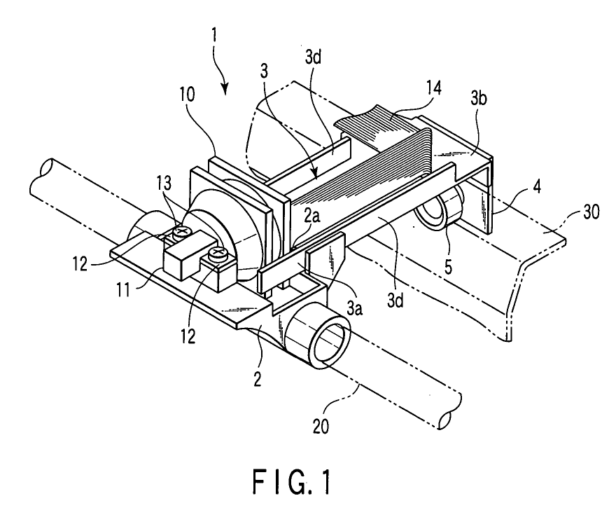

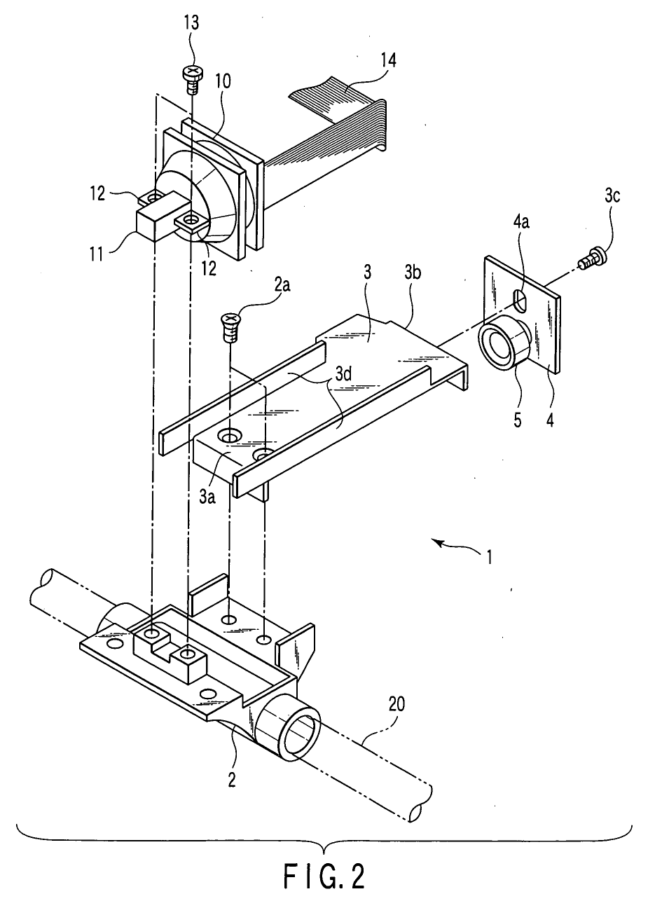

A head carrier 1 according to a first embodiment of the present invention will be explained with reference FIGS. 1 and 2. The head carrier 1 shown in FIG. 1 carries a print head 10 of a dot matrix printer. The head carrier 1 has a head mount 2 and a mount support 3. The head mount 2 is slidably fitted to a carrier shaft 20 that is placed in the direction crossing the direction of supplying the recording medium. The head mount 2 is connected with a belt, and moved by a driving unit along the printing surface of the recording medium.

One end 3a of the mount support 3 is fixed to the head mount 2 with a screw 2a, and the other end 3b is slidably fitted in the carrier guide 30. The carrier guide 30 is placed parallel to the carrier shaft 20. The other end 3b of the mount support 3 has a guide roller 5 supported by a bracket 4. The guide roller 5 holds the carrier guide 30 between itself and the other end 3b of the mount support 3.

The bracket 4 has an elongate fitting hole 4a in the direction of pressing the guide roller 5 to the carrier guide 30. The bracket 4 is fixed to the other end 3b of the mount support with a screw 3c inserted into the fitting hole 4a. The fitting hole 4a is an example of an adjusting means to change the position of the head carrier 1 to the printing surface of the recording medium.

The print head 10 has a fixing piece 12 on both sides of a nose 11, and is fixed to the head carrier 1 with a screw 13 by using the fixing piece 12. The print head 10 pushes out the built-in wire by a solenoid and armature for printing. A cable 14 connected to each solenoid is wired along the mount support 3 as shown in FIG. 1.

When the solenoid is powered, the print head 10 is heated. Heat is generated also when the wire collides with the recording medium. When the wire collides with the recording medium, the print head 10 receives a repulsive force.

Therefore, the head mount 2 preferably has excellent rigidity and heat resistance. In this embodiment, the head mount 2 is formed by die-casting aluminum alloy. In this case, the head mount 2 slidingly contacts the carrier shaft 20. Therefore, the heat inputted from the print head 10 to the head mount 2 is conducted to the carrier shaft 20, and not conducted to the mount support 3.

Thus, the mount support 3 can be made of a material with a low thermal conductivity since heat radiation is irrelevant. In this embodiment, the mount support 3 is made of synthetic resin with a high rigidity, for example, polycarbonate including a glass fiber. The mount support 3 has a rib 3d at both side edges of the head carrier 1 in the moving direction. It is permitted to use a thermoplastic resin material used generally as engineering plastic or an injection molded thermosetting material.

As described above, the head carrier 1 comprises two parts, the head mount 2 and mount support 3, or more parts including the bracket 4 and guide roller 5. Therefore, the head carrier configured to be made of materials suitable for the performance required by each part. It is also possible to reduce the manufacturing unit cost by selecting cheap materials from the applicable materials.

The print head 10 generates a magnetic fluctuation by the built-in solenoid in the surroundings during printing. If the head carrier 1 is not made of conductive material and properly grounded, the magnetic fluctuation may be amplified, and electromagnetic interference is caused as a result. Contrarily, in this embodiment, the parts made of aluminum alloy of the head carrier 1 are limited to the head mount 2, and the mount support 3 is made of non-conductive synthetic resin, there is little possibility to cause electromagnetic interference.

In the other embodiments explained hereinafter, the component having the same function as the head carrier 1 of the first embodiment is denoted by the same reference numeral and description will be omitted. The components having the same function in the other embodiments explained later are already in previous embodiments, and repetition of the same description will be omitted.

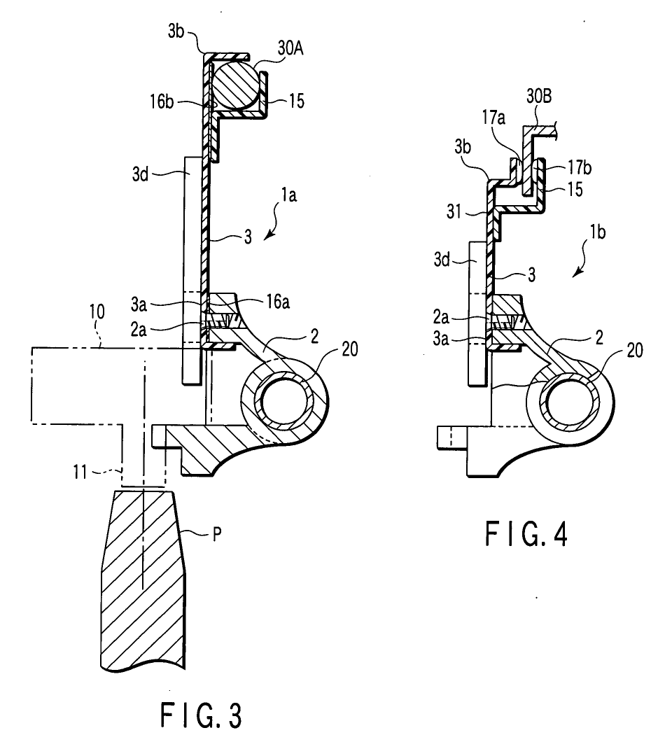

Next, a head carrier 1a according to a second embodiment of the present invention will be explained with reference to FIG. 3. In FIG. 3, the nose 11 of the print head 10 faces a platen P. The head carrier 1a has a guide bracket 15 at the other end 3b of the mount support 3. A carrier guide 30a is a bar arranged parallel to a carrier shaft 20. A guide bracket 15 holds the carrier guide 30a so as to clip in the space to the other end 3b of the mount support 3.

The guide bracket 15 is fixed to the mount support 3 with a screw. If the guide bracket 15 is made of the same material as the mount support 3, for example, synthetic resin, they may be glued with each other. To adjust exactly the position of the print head 10 to the printing surface of the recording medium, insert shim plates 16a and 16b in the joint between the head mount 2 and mount support 3, and between the mount support 3 and carrier guide 30a, as shown in FIG. 3.

The head carrier 1a uses the same head mount 2 and mount support 3 as those in the head carrier 1 of the first embodiment, and the structure to hold the other end 3b of the mount support 3 to the carrier guide 30a is different. Even if the type of dot matrix printer differs and the peripheral parts of the print head 10 become a little different, the same parts can be used. As a result, even if a minor change occurs, it is unnecessary to manufacture a new mold for die-casting.

Particularly, the head mount 2 formed by die-casting can be reduced a unit cost of the parts which is manufactured by using the same parts. In addition, as the same data can be used for the calculation of strength and analysis of thermal stress, the development costs can also be reduced.

Next, a head carrier 1b according to a third embodiment of the present invention will be explained with reference to FIG. 4. The head carrier 1b is configured by combining a head mount 2 of the head carrier 1 of the first embodiment with a mount support 31 with different dimensions. The head carrier 1b has a guide bracket 15 at the other end 3b of the mount support 31. The other end 3b of the mount support 31 and guide bracket 15 have guide shoes 17a and 17b, which are contacting to nip the carrier guide 30b. The carrier guide 30b is formed by bending a panel like the carrier guide 30 shown in FIG. 1.

Considering the case of adjusting the position of the print head to the printing surface of the recording medium, replace the guide shoe 17a or 17b, or provide a margin for grinding in the guide shoe 17a in the mount support 3. Otherwise, insert the shim plate 16 between the head mount 2 and mount support 3.

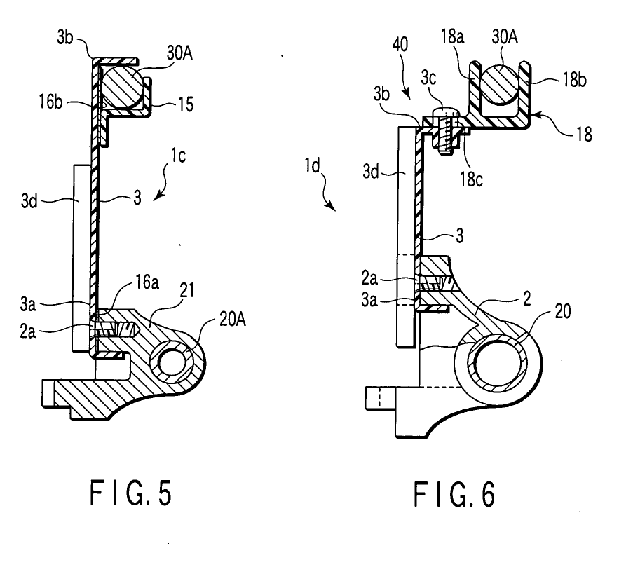

Next, a head carrier 1c according to a fourth embodiment of the present invention will be explained with reference to FIG. 5. The head carrier 1c comprises a head mount 21 with a size different from the head mount 2 of the first embodiment, and a mount support 3 of the head carrier 1 of the second embodiment. The head mount 21 is adopted when mounting a print head having outside dimensions and specifications different from the print head 10. For example, when selecting one of a 9-wire head and 24-wire head according to the specifications, the head mount may be replaced. When adopting a carrier shaft 20A with a different shaft diameter to that of the carrier shaft 20, the head mount may be replaced.

Next, a head carrier 1d according to a fifth embodiment of the present invention will be explained with reference to FIG. 6. The head carrier 1d comprises the head mount 2 of the first embodiment, and a mount support 32 with a different form. A holder 18 that holds a carrier guide 30A is provided at the other end 3b of the mount support 32. The holder 18 has flanges 18a and 18b to sandwich the carrier guide 30A from the direction of moving the head mount 2 rotationally around the carrier shaft 20.

The holder 18 has an elongate fitting hole 18c provided in the direction crossing the carrier guide 30A, and is fixed to the mount support 3 with a screw 3c inserted into the fitting hole 18c, as in the first embodiment. The position of the print head on the printing surface of the recording medium can be exactly adjusted by displacing the relative position of the holder 18 on the mount support 3 within the range of the fitting hole 18c. Provision of this adjustment mechanism 40 ensures an adjustment margin larger than the shim plates 16a and 16b. Therefore, the dimensions around the print head can be made compact by reducing the distance between the carrier shaft 20 and carrier guide 30A.

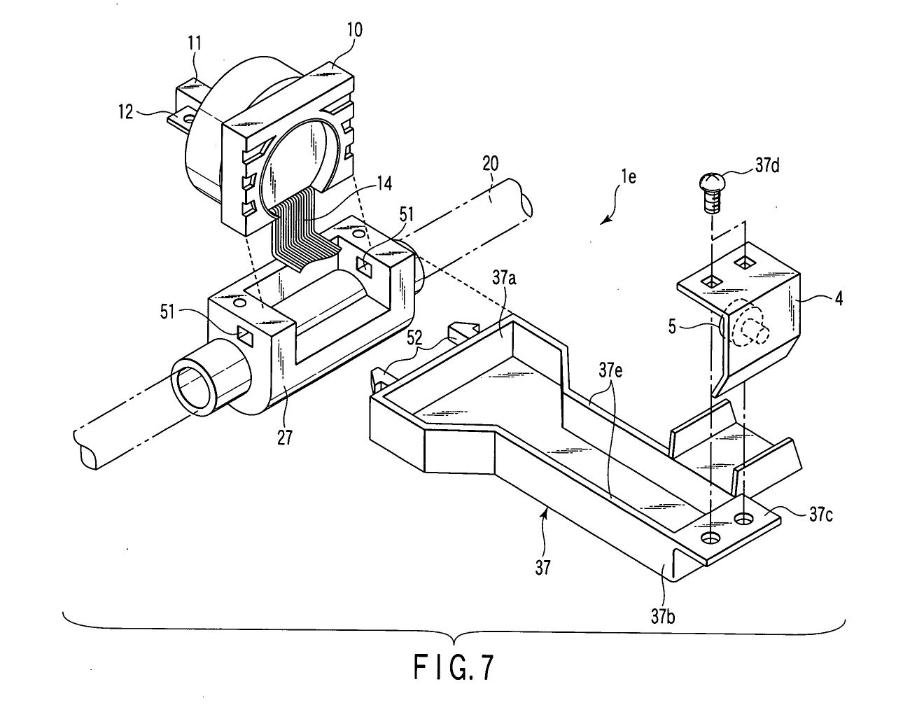

Next, a head carrier 1e according to a sixth embodiment of the present invention will be explained with reference to FIG. 7. The head carrier 1e has a head mount 27 and a mount support 37. The print head 10 is fixed to the head mount 27 with a not-shown attachment. The head mount 27 is formed by die-casting aluminum alloy. The mount support 37 is formed by molding synthetic resin.

An engagement hole 51 is provided at both end portions of the head mount 27 the engagement holes 51 are pierced in the direction parallel to the carrier shaft 20. The mount support 37 has a pair of hooks 52 at one end 37a. The hooks 52 are placed back to back facing the opposite direction as shown in FIG. 7, and engaged with the engagement holes 51.

The mount support 37 has a bracket mounting port 37c at the other end 37b. The bracket 4 assembled with the guide roller 5 is fixed to the bracket mounting port 37c with a screw 37d.

The mount support 37 has ribs 37e rising at the peripheral edge of it. A cable 14 led from the print head opposite the nose 11 side is placed between the ribs 37e. The position of the print head 10 on the printing surface of the recording medium can be changed by inserting a shim plate between the bracket mounting port 37c and bracket 4.

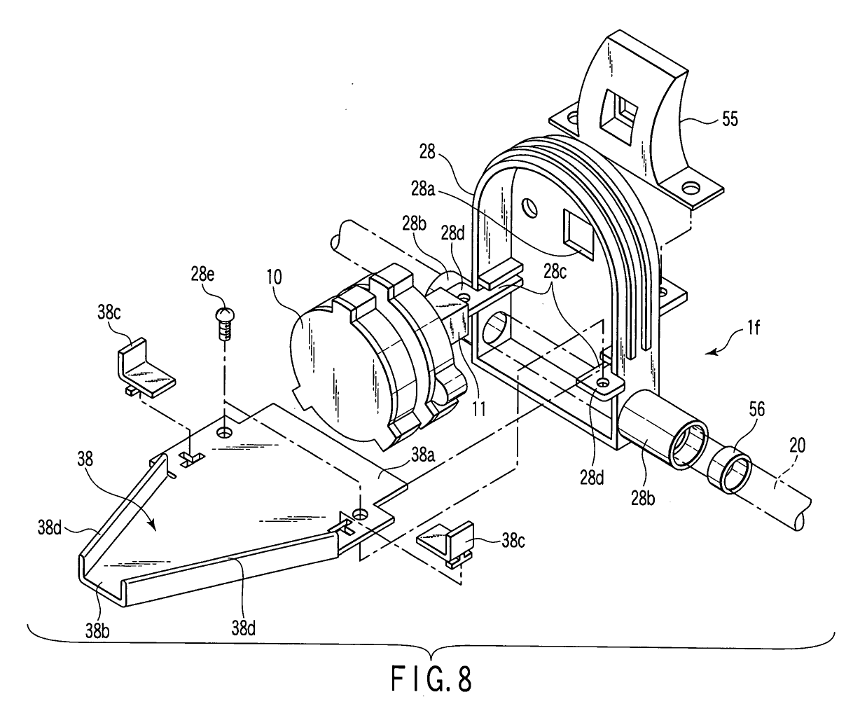

Next, a head carrier if according to a seventh embodiment of the present invention will be explained with reference to FIG. 8. The head carrier 1f has a head mount 28 and a mount support 38. The nose 11 of the print head 10 is inserted into the fitting hole 28a provided in the head mount 28. The print head 10 is fixed to the head mount 28 with a screw from the side projecting the nose 11. A ribbon mask 55 is fixed to the head mount 28, just like surrounding the projected nose 11. A bush 56 is fitted to the sleeve 28b of the head mount 28 to smooth the movement of the head mount 28 to the carrier shaft 20, and to avoid dust collecting therebetween.

One end 38a of the mount support 38 is inserted into a slot 28c provided between the print head 10 and carrier shaft 20 in the head mount 28. The mount support 38 is fixed to tabs 28d provided in the insertion side of the slot 28c with a screw 28e. The other end 38b of the mount support 38 extends in the direction separating away from the carrier shaft 20, and becomes slender toward the end. A hook 38c is fitted to the mount support 38 close to the head mount 28, in addition to the rib 38d. The mount support 38 is combined with the carrier guide to permit adjustment of the position of the print head 10 on the printing surface of the recording medium.

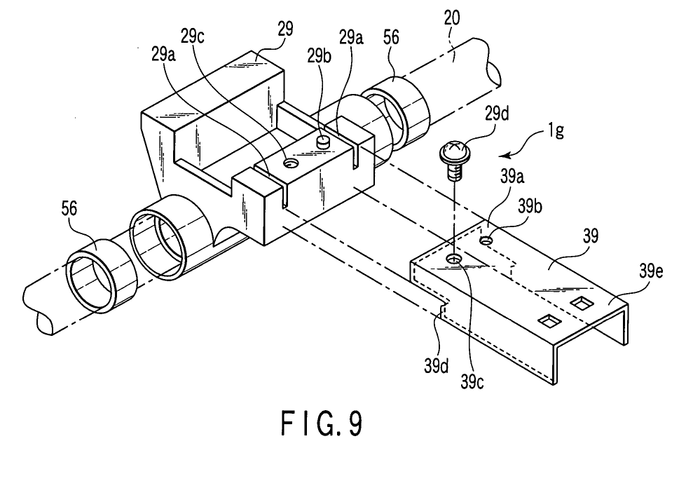

Next, a head carrier 1g according to an eighth embodiment of the present invention will be described with reference to FIG. 9. The head carrier 1g has a head mount 29 and a mount support 39. The head mount 29 has two slots 29a made in the direction crossing a carrier shaft 20, a positioning projection 29b provided between these slots 29a, and a fixing screw hole 29c.

The mount support 39 is bent into a box shape at the positions corresponding to the slots 29a. At one end 39a of the mount support, a positioning deciding hole 39b and a screw inserting hole 39c are formed. The mount support 39 is combined with the head mount 29 in the state that the edges of both bent sides are inserted into the slots 29a, and the positioning hole 39b is fitted with the positioning projection 29b.

In this state, the mount support 39 is fixed to the head mount 29 with a screw 29d inserted into the screw insertion hole 39c. At this time, an end 39d of the mount support 39 cut to meet the shape of the head mount 29 comes in tight contact with the outside surface of the head mount 29. The other end 39e of the mount support 39 has a hole for connecting a guide roller and bracket. The shape of a seat surface to mount the print head 10 is omitted. Because the seat surface is formed similarly in the head mount 2 shown in FIG. 2.

As described above, any one of the head carriers 1, 1a, 1b, 1c, 1d, 1e, 1f and 1g shown in the first to eighth embodiments is composed of two or more parts. The head mounts 2, 21, 27, 28 and 29 to which the print head 10 is fixed are made of materials such as aluminum alloy with excellent thermal conductivity, compared with the mount supports 3, 31, 32, 37, 38 and 39.

As the head mounts 2, 21, 27, 28 and 29 that firmly support the print head 10 on the carrier shaft 20 are made of materials of excellent thermal conductivity, the heat generated in the print head 10 is transmitted to the carrier shaft 20 to reduce the heat conducted to the mount support side. Thus, the mount supports 3, 31, 32, 37, 38 and 39 can be made of a cheap material, since heat resistance is irrelevant.

According to the above description, the head carrier can be manufactured at a low cost without disturbing the heat radiation of the head carrier. Variation of combination of the head carrier to meet various types of print head or housing of a dot matrix printer can be accepted by the less number of parts, and many kinds of product can be supplied to the market at low costs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the invention as defined by the appended claims and equivalents thereof.

1. A head carrier on which a print head of a dot matrix printer is mounted, comprising:
a head mount which is made of a conductive material, is fitted to a carrier shaft extending in a direction crossing a direction of supplying a recording medium, and is movable along a printing surface of the recording medium; and
a mount support which is made of a non-conductive material, and has a first end connected to the head mount and a second end which is fitted movably along a carrier guide extending parallel to the carrier shaft.

2-3. (canceled)

4. The head carrier according to claim 1, wherein the mount support has a guide roller at the second end.

5. The head carrier according to claim 1, wherein the mount support is fixed to the head mount with at least one screw.

6. The head carrier according to claim 1, wherein the mount support has at least one hook at the first end, and the head mount has at least one engagement hole, and the hook is engageable in the engagement hole.

7. The head carrier according to claim 1, wherein the mount support supports a cable extending from the print head, which is fixed to the head mount.

8. A head carrier on which a print head of a dot matrix printer is mounted, comprising:
a head mount which is fitted to a carrier shaft extending in a direction crossing a direction of supplying a recording medium, and is movable along a printing surface of the recording medium; and
a mount support which has a first end connected to the head mount and a second end which is fitted movably along a carrier guide extending parallel to the carrier shaft;
wherein the mount support supports a cable extending from the print head, which is fixed to the head mount.
